(19) United States
(12) Patent Application Publication
(10) Pub. No.: US 2014/0127634 A1
(43) Pub. Date: May 8, 2014

(54) HEATING DEVICES AND METHODS WITH AUTO-SHUTDOWN

(71) Applicant: HeatGenie, Inc., Austin, TX (US)

(72) Inventors: Brendan Coffey, Austin, TX (US); Krzysztof Kwiatkowski, Austin, TX (US); Travis Bookout, Kyle, TX (US)

(73) Assignee: HeatGenie, Inc., Austin, TX (US)

(21) Appl. No.: 14/073,639

(22) Filed: Nov. 6, 2013

Related U.S. Application Data
(60) Provisional application No. 61/722,888, filed on Nov. 6, 2012.

(51) Int. Cl. A47J 31/58; F24J 1/00; A47J 36/28

(52) U.S. Cl. CPC A47J 31/58; A47J 36/28; F24J 1/00
USPC 432/4; 126/263.08

(57) ABSTRACT

A modular heating system and method is presented that automatically shuts down the chemical reaction within a heater if the heat generated by the reaction is excessive. Heaters are designed to generate sufficient heat to warm food or drink in an adjacent container. If the container is empty, or if the heater is dislodged from the container, the heat generated by the heater will become dangerously high. When excessive heat is generated by the reaction in the heater, systems and methods of the present invention respond by terminating the reaction before all of the reaction mixture has reacted.

### CROSS-REFERENCE TO RELATED APPLICATIONS

This application claims priority based upon prior U.S. Provisional Patent Application Ser. No. 61/722,888 filed Nov. 6, 2012 in the names of Brendan Coffey, Krzysztof Kwiatkowski and Travis Bookout, entitled “Containers, Devices, and Method for Convenience and Safe Self-Heating and Brewing of Hot Foods and Beverages,” the disclosure of each of which are fully incorporated herein by this reference.

### BACKGROUND OF THE INVENTION

FIGS. 1a and 1b illustrate one form of a modular heater mounted in the base of a container such as a beverage can. The heater is dormant until activated. The heater is activated by pressing on its flexible lid which in turn compresses a blister which bursts to expel a tiny droplet of starting fluid onto a starting pellet. A reaction between the starting fluid and pellet creates intense localized hot spot which, as shown in FIG. 1b, initiates the main heating reaction that then propagates through the solid fuel mix. Thermal energy generated by the heater is transmitted through the contacting surfaces of the heater and the beverage can wall to heat the package contents.

Various solid-state reaction chemistries may be used in the modular heater of this invention to provide a compact, lightweight, powerful heat source. The energy content and the heating rate are configurable via adjustments to the mass or composition of the internal fuel mix for use with different portion types or sizes. As an indication of the high energy and power capability, it is easily shown that a small heater can raise the temperature of 12 ounces of a beverage by 70° F. in two minutes.

In normal operation, by design the energy of the heater is safely transmitted to the food or beverage portion in the can. However if the food portion is not present to act as a heat sink (for example a child spilled the package contents before starting the heater) then without some form of override the empty package would reach unacceptably high temperatures. Similarly a heater removed from the package could reach extreme temperatures.

Intrinsic safety is essential for a mass consumer market and in consumer packaged goods food and beverage products, a good general design guideline is that the container contents should typically not exceed preferred serving temperatures of about 60 to 70 deg C. (about 140 to 160 deg F.) and for user comfort and safety no point on the exposed consumer contact surface of the package should exceed about 54 deg C. (130 deg F.) under any reasonably anticipated consumer use or misuse.

Modular heaters that assemble into the base of containers to heat food and beverage contents contained therein to serving temperature are known in the art. For example, U.S. patent applications describe a compact modular heating element that inserts into the base of a food can or other container with technology related to the present invention: U.S. patent application Ser. No. 12,419,917 titled “Solid-State Thermite Composition Based Heating Device,” U.S. patent application Ser. No. 12,570,822 titled “Package Heating Apparatus and Chemical Composition,” U.S. patent application Ser. No. 12,715,330 titled “Package Heating Apparatus,” and U.S. patent application Ser. No. 13,177,502 titled “Package Heating Device and Chemical Compositions for Use Therewith.”

These heater elements efficiently store chemical energy in contained solid state chemical reactants and are simply activated, by pushing a button on its surface or other means, to promptly release thermal energy. The thermal energy is transmitted through the wall of an immediately adjacent container to uniformly heat the interior contents. The features and functionality of the heaters described in the foregoing applications, each of which was filed in the name of the present inventors, are incorporated into this application.

In certain circumstances it is desirable when heating food in a container to control or terminate the heating process to prevent overheating of the package assembly or the food or beverage products and, more importantly, to protect the user from burns or explosions. Effective and efficient automated shutoff devices and methods are not known in the art. There is a need, therefore, for automated methods and systems for stopping automated heating devices from heating beyond their intended limit.

### SUMMARY OF THE INVENTION

The current invention incorporates a passive thermal safety mechanism into the modular heater to provide for greater safety such that if the heater is activated when not in direct contact with an appropriate heat sink (for example a filled container), it will start but then turn itself off. The heater effectively senses its environment by whether the heat it generates is being taken away fast enough. If it is not, then higher than normal temperatures build up inside the heater and in the present invention will activate a mechanism that interrupts continued reaction. As shown in FIGS. 2a and 2b, activating the heater energizes it and enables it to “sense” its environment by transmitting thermal energy through the heater wall; if the heat transmitted to the package is not taken away at a sufficient rate, then internal temperature of the heater builds up, activating a physical response that shuts down the chemical reaction as shown in FIG. 2b.

The auto-shutdown functionality described and claimed herein provides a passive safety feature that is triggered to shutdown the heater when needed to prevent overheating. Auto-shutdown is achieved by introducing additional components into the heater, and can be used in conjunction with other safety components.

The auto-shutdown functionality is activated when the contents of the container are spilled or removed by a user prior to activation of the heater, or if the heater is dislodged from the package, intentionally or inadvertently. In addition, the auto-shutdown functionality would be implemented upon the accidental activation of bare heaters not yet installed into packages in transportation and assembly handling operations.

The present invention provides auto shutdown functionality within the heater device. The functionality includes a passive thermal shutdown mechanism which will terminate the heat generation reaction inside the heater when the absence of the heat sink is “sensed” as excessive internal temperature build-up within the heater caused by the inability to effectively transfer the heat being generated. The auto-shutdown is thus a form of “intelligent” or “smart” packaging, that is it involves the ability to sense or measure an attribute of the product and trigger active packaging functions.

In addition to providing consumer thermal safety benefits, the auto-shutdown may beneficially assure that inadvertent activation of a single heater in a container of closely packed heaters being stored or transported would not lead to thermal activation of adjacent heater elements, a potential fire hazard. Given the safety implications the auto-shutdown mechanism must be highly reliable.

Actuation of the auto-shutdown when needed is generally passive to avoid potential user error. It is generally desirable that the auto-shutdown mechanism always acts when needed to prevent unsafe overheating, yet it should not be prone to operate when not required.

The auto-shutdown device of the present invention does not substantially detract from or negate the existing beneficial characteristics of the self-heating technology of this invention and prior inventions, so that the heater device construction will remain relatively small, simple, robust, easy to manufacture, and economically low-cost.

The present invention also provides a controllable output that enables, for example, designing in a defined acceptable maximum temperature that the heater surface should not exceed.

Relative to the case of the completely empty package there are different degrees of overheating, for example, a partially emptied package or partially immersed heater. The auto-shutdown sensitivity can optimally be tuned to determine under what conditions the auto-shutdown response is triggered.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1a is a cross-sectional view of a modular heater in a food container prior to initiation of the heater.

FIG. 1b is a cross-sectional view of a modular heater in a food container after initiation of the heater.

FIG. 2a is a cross-sectional view of a modular heater with auto-shutdown functionality after initiation of the heater in a full food container.

FIG. 2b is a cross-sectional view of a modular heater with auto-shutdown functionality after initiation of the heater in an empty food container.

FIG. 3 is a diagrammatic cross-sectional view of a solid state modular heater showing the reaction pathway without internal components for auto-shutdown functionality.

FIG. 4 is a diagrammatic cross-sectional view of a solid state modular heater showing the reaction pathway with internal compartments for auto-shutdown functionality.

FIG. 5a is a diagrammatic cross-sectional view of a solid state modular heater showing the reaction pathways with internal components to accomplish auto-shutdown after initiation of the heater in a full food container.

FIG. 5b is a diagrammatic cross-sectional view of a solid state modular heater showing the reaction pathways with internal components to accomplish auto-shutdown after initiation of the heater in an empty food container.

FIG. 6 is a diagrammatic cross-sectional view of a solid state modular heater showing the initial reaction pathway and dynamic heat balance in an activated heater with sensing and actuation auto-shutdown functionality.

FIG. 7 is a diagrammatic cross-sectional view of one embodiment of an auto-shutdown mechanism in which the thermally sensing material is a solder and the mechanical actuation component is a compressed spring.

FIG. 8a is a diagrammatic cross-sectional view of a solid state modular heater showing auto-shutdown functionality by insensitivity to activation in water.

FIG. 8b is a diagrammatic cross-sectional view of a solid state modular heater showing auto-shutdown functionality by sensitivity to activation in air.

FIG. 9 is a graph showing the time/temperature correlation for activation of auto shutdown mechanism in an empty can and in a full can.

FIG. 10 is a diagrammatic cross-sectional view of an auto-shutdown mechanism in which the thermal sensing material is a solder and the mechanical actuation component is a compressed spring.

FIG. 11a is a perspective view of the auto-shutdown mechanism of a solid state modular heater showing the operation when the container is full.

FIG. 11b is a perspective view of the auto-shutdown mechanism of a solid state modular heater showing the heater operation when the container is empty and the device is in auto-shutdown mode.

FIGS. 12a through 12e show a top view, a side view and three plan and cross-sectional views of one embodiment of the auto-shutdown mechanism of the present invention.

FIGS. 13a through 13c show a top view, a side view and a cross sectional view of one embodiment of the auto-shutdown mechanism of the present invention.

FIGS. 14a through 14c show a top view, a side view and a cross sectional view of one embodiment of the auto-shutdown mechanism of the present invention.

FIG. 15a shows perspective cross sectional view of another embodiment of an auto-shutdown mechanism integrated into a heater.

FIG. 15b shows a cross sectional view of the same embodiment of an auto-shutdown mechanism integrated into a heater.

FIG. 15c shows a cross-sectional view of a heater is which all of the reaction mixture has reacted.

FIG. 15d shows a cross-sectional view of a heater is which the auto-shutdown feature has prevented all of the reaction mixture from reacting.

FIG. 16 shows an exploded view of one embodiment of the heater of the present invention installed in a container.

FIG. 17a shows a front cross sectional view of another embodiment of the a heater installed in a non easy opening end of a 3-piece can.

FIG. 17b shows a front, top, right cross-sectional view

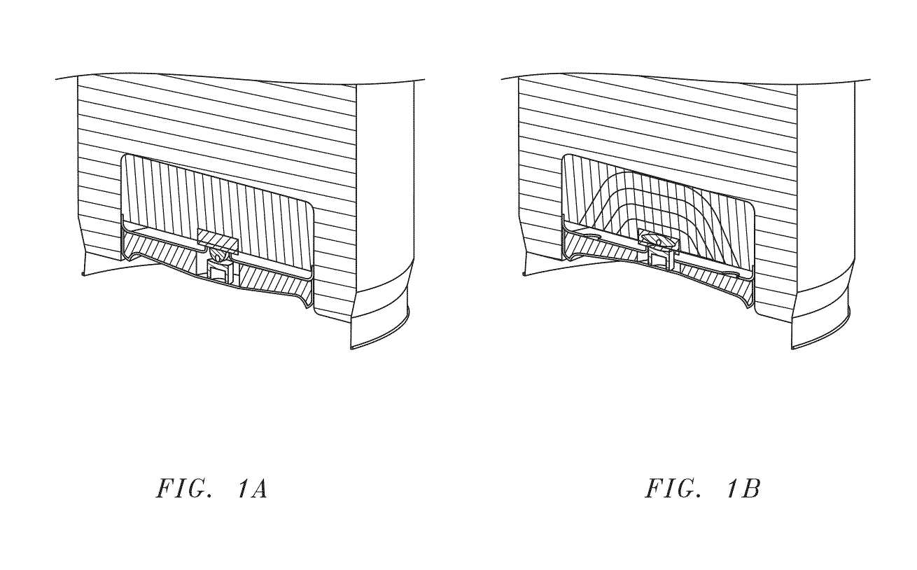

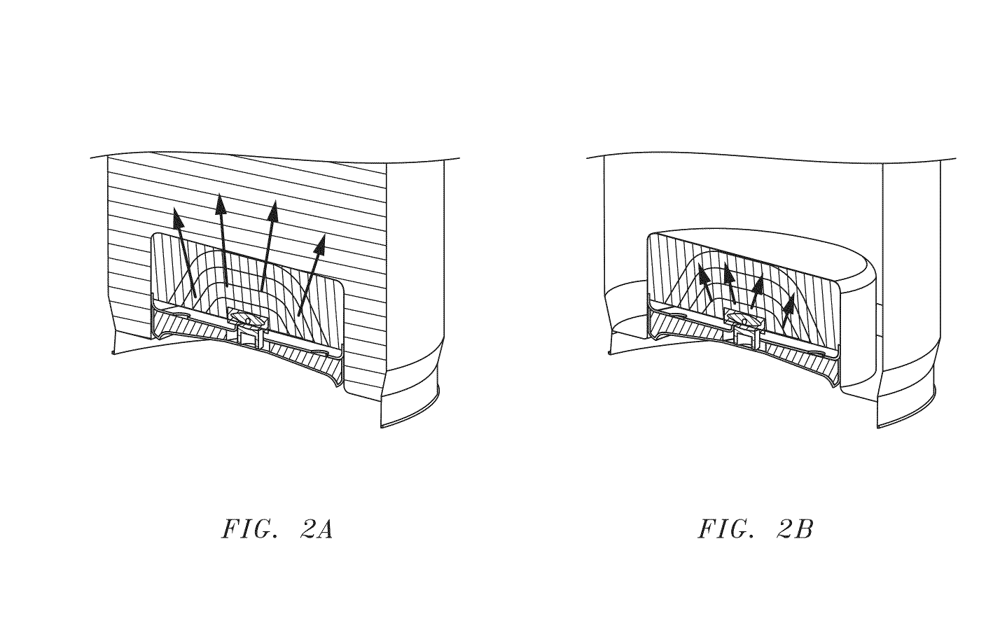

### DETAILED DESCRIPTION

The present invention is directed to an apparatus and method for providing passive thermal shutdown capability to a heating device. The configuration and use of the presently preferred embodiments are discussed in detail below. It should be appreciated, however, that the present invention provides many applicable inventive concepts that can be embodied in a wide variety of contexts other than devices for heating food and beverages. Accordingly, the specific embodiments discussed are merely illustrative of specific ways to make and use the invention, and do not limit the scope of the invention. In addition, the following terms shall have the associated meaning when used herein:

“can” means and includes any receptacle in which material may be held or carried, including without limitation a can, carton, or jar;

“heater” means and includes any device in which reactants react to generate heat;

“opening” means and includes any perforation or aperture through which fluid may flow;

“shutdown” means and includes any hindrance or termination of a chemical reaction; and

“sleeve” means and includes any flexible, semi-rigid or rigid material within which materials may be retained.

As will be apparent to those skilled in the art, many of the heating devices are depicted herein without each and every component required for full functionality, such as, for example, devices shown without a flexible actuating lid or a blister assembly. In each case the depiction is intended to show the functional aspects of the heater for a better understanding of the invention and should not necessarily be construed as including all of the elements of a fully operational device.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. The present specification is intended to be taken as a whole and interpreted in accordance with the principles of the present invention as taught herein and understood to one of ordinary skill in the art.

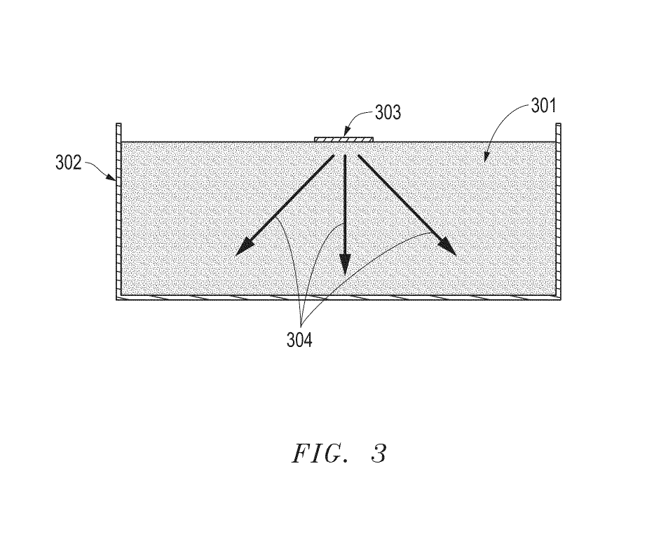

Referring now to FIG. 3 which shows a diagram of a heater construction of prior art without any auto-shutdown capability. In this configuration, the pre-mixed fuel-oxidizer reaction mix is essentially a mixture of reactants 301 distributed throughout the base of the cylindrical heater cup 302. The mixture of reactants 301 is ignited near its center by various means known in the art such as, for example, a starting pellet 303. The chemical reaction that releases the energy, proceeds internally to the heater as a solid flame front. As shown in FIG. 3, the reaction pathway 304 spreads generally radially outward from the starting pellet 303, continuing to propagate throughout the interior until the entire mixture of reactants 301 has reacted.

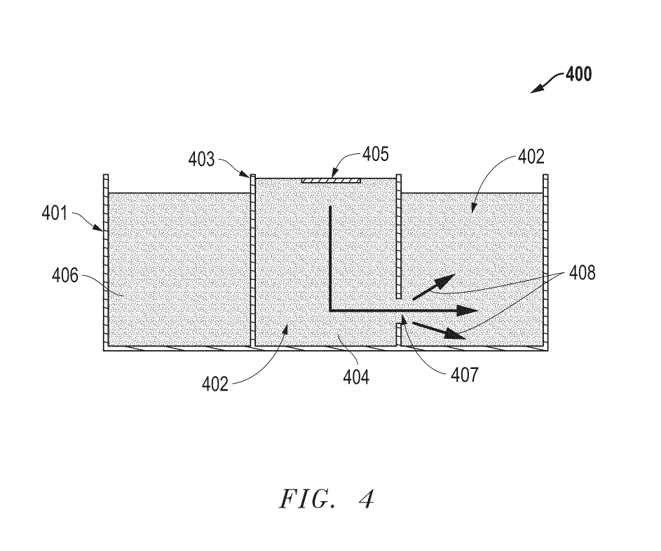

One embodiment of the auto-shutdown device of the present invention is shown in FIG. 4. It is useful to establish some boundaries within the heater cup 401 to compartmentalize the fuel-oxidizer reaction mix 402 and act as barriers when the auto-shutdown function is invoked, similar to the way that fire walls are used in buildings to interrupt a spreading flame front. For example, by dispersion of thermal energy a boundary wall constructed of thin metal sheet of sufficient thickness (approximately 0.010 inch or more) can be used to block the transmission of the solid flame front in the interior of a modular solid state heater.

The boundaries 403 effectively compartmentalize the fuel-oxidizer reaction mix 402 into at least one initial portion 404 that is initiated by the starter pellet 405, and one or more reserve secondary portions 406 that will only be initiated if the auto-shutdown functionality is not triggered. As further shown in FIG. 4, the fuel-oxidizer reaction mix 402 in adjacent compartments are largely separated yet do still remain linked in physical contact by one or more distinct propagation channels 407. The propagation channels 407 are normally open to allow reaction to proceed between boundaries 403. Implementation of auto-shutdown involves interrupting or closing off the propagation channels 407 to break the contiguous contact of fuel-oxidizer reaction mix 402 in adjacent compartments, the implementation of which is described in more detail below. By interrupting or closing off the propagation channels 407, the reaction flame front propagation 408 is halted, analogous to a blown fuse interrupting the flow of electric current.

Many compartment geometries are possible as will be described in the examples, but those that yield simple low-cost parts are preferred for this application. Shown in the cross section diagram of FIG. 4, one embodiment of the boundary wall 403 is a simple flanged cylindrical metal tube centrally placed into the disk shaped heater cup 401, and affixed to the heater cup 401 bottom, for example, by welding. In some embodiments, this component may be referred to as a “stovepipe”. The stovepipe and heater cup 401 of FIG. 4 are both filled with fuel-oxidizer reaction mix 402, and the centrally placed starter pellet 405 is now located in the interior of the stovepipe. Thus the total fuel-oxidizer reaction mix 402 of the heater 400 is now divided into an interior portion 404 within the metal tubular wall of the stovepipe and the remainder of the fuel-oxidizer reaction mix 402 is located in the exterior regions 406 between the stovepipe and the heater cup 401 wall.

When the starter pellet 405 in FIG. 4 is initiated, the path of the reaction flame front 408 first proceeds down through the stovepipe tube, with a velocity that is a function of its formulation, density, and other physical parameters. The propagation channel in FIG. 4 is a shown as a small opening 407 in the boundary wall 403 of the stovepipe located near the bottom flange and through this opening 407 there is a contiguous connective channel of fuel-oxidizer reaction mix 402 from the interior portion 404 to the reaction mix portion 406 outside the stovepipe. When the flame front 408 reaches the opening 407 near the base of the heater cup 401, it can propagate through this opening 407, igniting the secondary reaction mix portion 406 outside of the stovepipe interior compartment. FIG. 4 depicts one embodiment of the placement of the opening 407 and the propagation of the reaction in the absence of auto-shutdown.

Blocking of the opening 407 or otherwise interrupting the continuity of the reaction mix phase through the opening 407 will prevent or inhibit propagation of the reaction flame front 408. This is the preferred behavior when the auto-shutdown is triggered through the various embodiments described below.

Compartment volumes provide a configurable ratio of the inner portion 404 of the initiated reaction mix 402 to reserve or unused portion 406 of the reaction mix 402. The geometric boundaries of the compartments will determine the relative mass ratios of primary initiated fuel mix 404 to the secondary unreacted fuel mix 406 and thus the resultant rise in temperature of the heater when the auto-shutdown mechanism is activated. The maximum available energy content of the heater is that which would be released if the reactive mixture 402 in all of the compartments 404 and 406 were consumed. In the event that the auto-shutdown mechanism terminates some portion of the reaction of the reaction mix 402, then the relative ratio of reactive masses in the initiated compartment 404 and reserve compartment 406 volumes provide a configurable ratio of initiated reaction mix 404 to reserve or un-used reaction mix 406. Thus the fractional energy release can be set by design of the compartment volumes and their relative masses of reactive mixture 402. As will be seen by those of skill in the art, the heaters could have more than two chambers in series such that the auto-shutdown can be actuated at more than one point in time in the system if needed.

The temperature increase of the system will be proportional to the energy released into the system, so for example if only 25% of the total onboard energy of the heater is released before the auto-shutdown is enacted then, with all other parameters staying about the same, only approximately 25% of the temperature increase will occur. Thus a designed ratio of initiated reaction mixture 404 to reserve reaction mixture 406 can be established via the compartmentalization geometry to establish a controlled maximum possible temperature excursion with the auto-shutdown.

For example, for the various compartment component dimensions given, Table 1 shows the percentage of the total reaction mixture 402 that would be initiated and the ratio of the uninitiated reaction mixture 406 to initiated reaction mixture 404 if the auto-shutdown occurred.

TABLE 1

| Stovepipe | Heater Cup | % of total mass | Ratio of reserve to |
|---|---|---|---|
| diameter (r) | Diameter (R) | initiated | initiated mass |
| 12 mm | 44 mm | 10.1% | 8.9:1 |
| 16 mm | 44 mm | 13.2% | 6.6:1 |
| 16 mm | 38 mm | 17.7% | 4.6:1 |

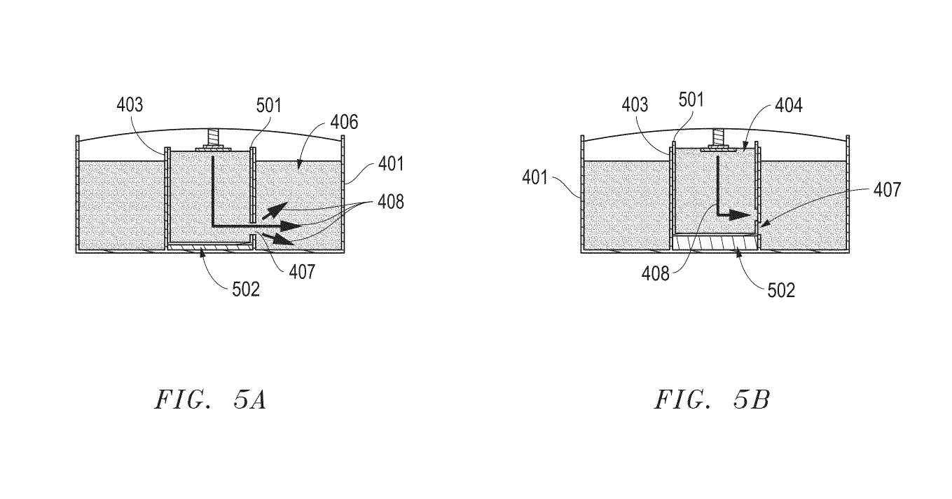

Having introduced boundaries to separate different reaction mix portions, two additional elements are required in certain embodiments to implement the auto-shutdown: a method or system of actuation to close off the propagation channels and a method or system of sensing excess temperature. FIGS. 5a and 5b show these elements diagrammatically on a sectioned view of the heater assembly. In FIGS. 5a and 5b, an additional cylindrical metal component, which we shall refer to as the “slide” 501 is fitted along the interior wall of the stovepipe 403. The slide 501 has a closed bottom to contain reaction mix and also incorporates a propagation opening closely corresponding to the opening 407 in the adjacent stovepipe. In FIG. 5a the slide 501 is in an initial rest position such that the propagation openings 407 in both the slide and stovepipe are aligned creating a continuous propagation channel from the interior core region 404 to the region outside the stovepipe 406. Beneath the base of the slide 501 in FIG. 5a is an unactivated auto-shutdown actuator which may take one of several forms as described below. In FIG. 5b the auto-shutdown actuator beneath the base of the slide 501 has been thermally activated so as to cause a relative movement between the slide 501 and stovepipe 403 such that the propagation openings 407 are no longer aligned and the propagation channel is blocked.

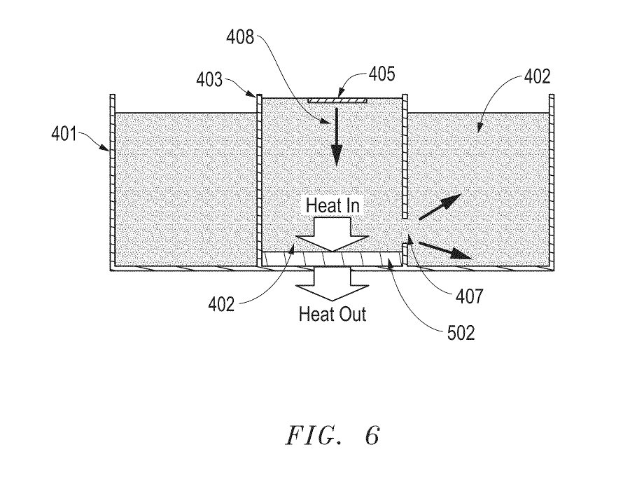

Starting the heater energizes both the sensing and actuation components of the auto-shutdown functionality through heat generated from the primary initiated reaction mixture 404. Sensing of over-temperature and actuation of the auto-shutdown are established as the result of dynamic heat balances within the energized heater. As shown in FIG. 6, as soon as the heater is activated it begins to transmit thermal energy 408 from hotter to cooler zones. Interior regions in the vicinity of the heater cup 401 wall are then effectively intermediate between a heat source (the primary initiated reaction mix) and any external heat sink or cooling medium if present.

Referring to FIG. 6 the initiated flame front 408 will project thermal energy ahead of itself down the stovepipe 403 toward the wall of the heater cup 401 at its base. Both the flame front 408 velocity and the rate of heat transfer down the stovepipe 403 are dependent upon, and may be adjusted through, physical parameters of the system such as: geometry of component parts, particle size and density of mix, material thermal properties, and heat transfer coefficients.

Some of the thermal energy that is transferred into the region at the base of the stovepipe 403 can be removed by heat transfer through the wall of the heater cup 401. The rate of heat removal through this surface will depend on the thermal mass (heat sink character) adjacent to the external surface as well as prevailing heat transfer coefficients. For example, heat removal through the wall of the heater cup 401 can increased by intimate contact of the heater surface with a cooling fluid, even when that cooling fluid is in an adjacent container.

Thermal energy will accumulate and temperature will increase in the region at the base of the stovepipe 403 over time in accordance with the relative rate of heat flow in and out. The sensing functionality of the auto-shutdown mechanism 502 can be achieved by incorporating into the heater, in the vicinity of the interior wall at the base of the stovepipe 403, a material that has a physical response to heating above some threshold or onset temperature. The physical responses may be phase changes (e.g. melting, sublimation), expansion or volume changes, or latent heat or energy absorption. A phase from a solid to gas state or liquid, are preferred forms of physical response in certain embodiments.

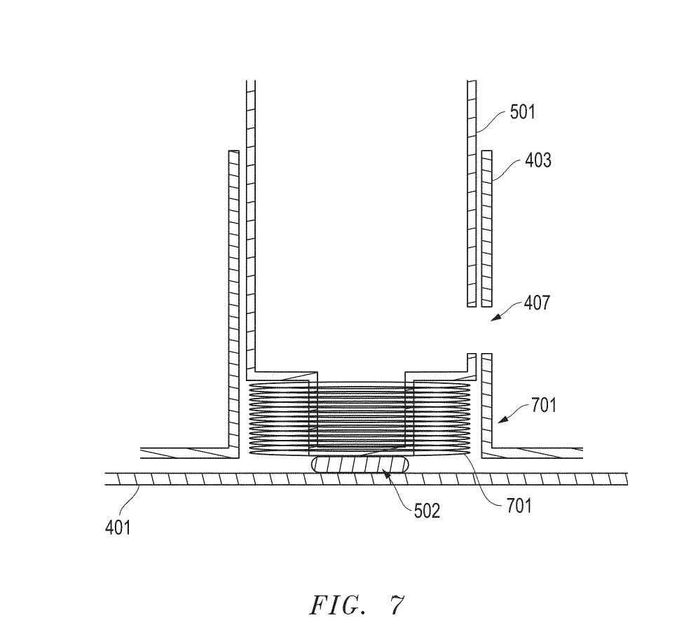

In some embodiments, solder is a suitable thermal sensing material that can be incorporated into an auto-shutdown mechanism 502. FIG. 7 is an example of a simple auto-shutdown mechanism 502 using solder as the thermally sensing material and a spring 701 as the mechanical actuator. Referring to FIG. 6, the slide 501 may be soldered to the interior wall of the heater cup 401 such that its propagation opening 407 is aligned with the propagation opening in the stovepipe 403 while at the same time a contained spring is put into compression. If the melt temperature of the solder 502 is exceeded, then its bond to the heater cup 401 will be broken. The stored energy in the spring will then act to push the slide 501 into a position wherein the openings 407 are no longer aligned and the propagation channel is closed. As will be described in the examples below, the solder composition can be selected to give any preferred melt temperature desired to effectuate the auto-shutdown.

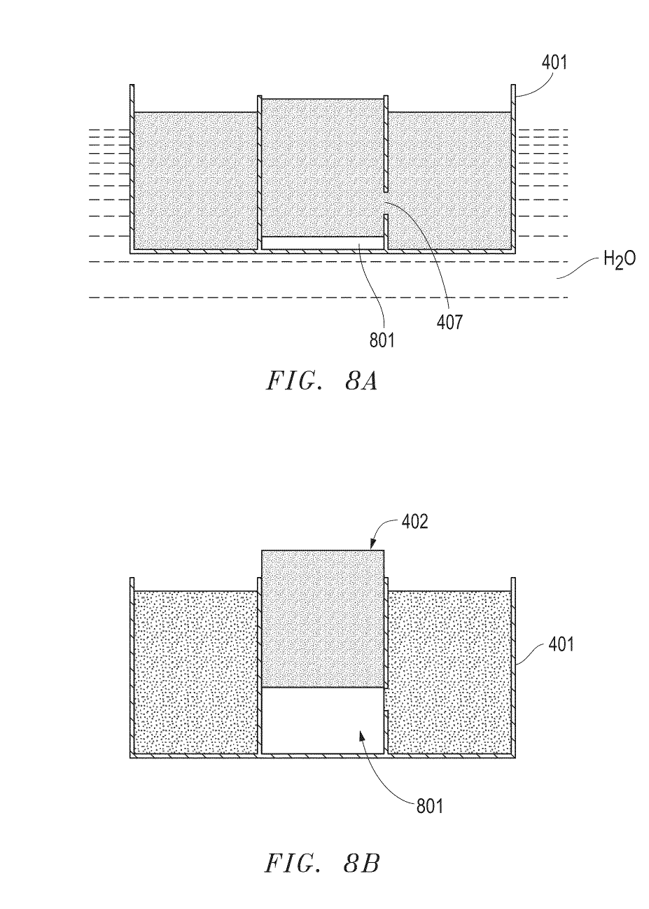

Another suitable class of thermally sensing material for the auto-shutdown control of a chemical heater is an endothermically decomposing solid (EDS) or other chemical compound that can be thermally decomposed to release gases and absorb energy at various activation temperatures. As shown in FIG. 8, the EDS can in fact play the role of both sensing material and actuator.

FIG. 8 depicts the heater cup 401 construction of FIG. 5 with the addition of a thin layer of an EDS material in the sensing region 801 at the base of the stovepipe 403. As shown in FIG. 8b, the auto-shutdown may be actuated if the thermal energy input to the sensing region 801 exceeds the rate at which the heat can be removed through the wall of the heater cup 401 such that the EDS reaches its decomposition temperature. The EDS is selected such that its decomposition will generate gas at a sufficient pressure, rate, and volume to perform work on moving the slide 501 relative to the stovepipe 403, these two components having been configured to act as a piston/barrel arrangement. If as in FIG. 8a, the wall of the heater cup 401 is in thermal contact with a sufficient heat sink, for example immersed in a cooling fluid, then the auto-shutdown will not be invoked and the reaction mixture 402 will react to completion.

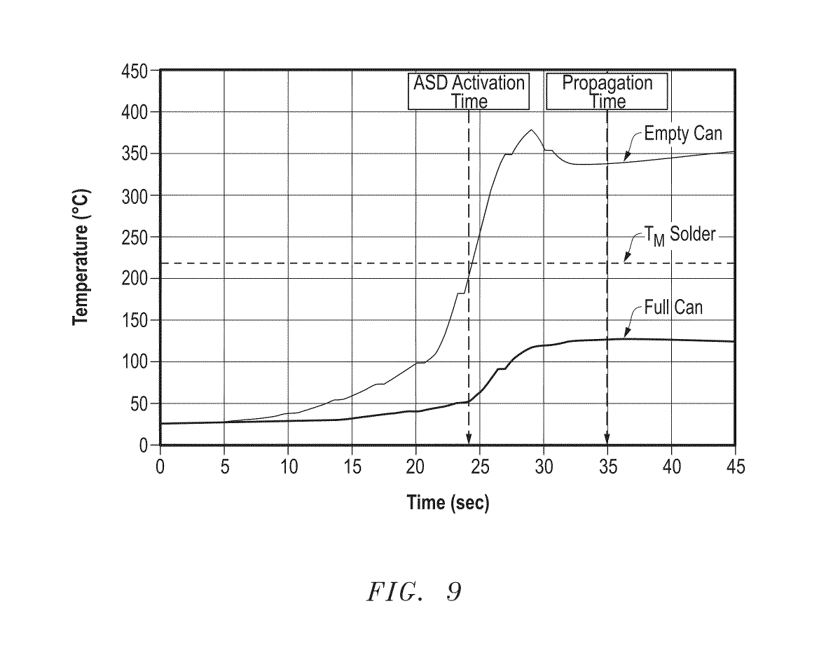

It will be appreciated by those with skill in the art that the dynamic thermal energy balances realized in the heater system must establish an appropriate timing sequence for the auto-shutdown to operate effectively to give the preferred response. If a shutdown response is required, the auto-shutdown sensing and actuation must be effectuated before the flame front reaches the propagation channel. FIG. 9 shows an example of a thermal response profile. The plots show the temperature at the bottom wall of the heater cup 401 (such as used in the FIG. 7 auto-shutdown example) versus time for a heater embedded in a container filled with ingredients and an empty container. For the empty container, the temperature at which solder melts is exceeded at around 24 seconds, thereby releasing the spring. Whereas the flame front does not reach the propagation channel 407 until about 35 seconds at which point the auto-shutdown would be achieved. The solder in the heater installed in the filled container does not reach its melt temperature in the time period shown. As long as it does not reach the solder melt temperature before 35 seconds, then the auto-shutdown will not activate and the reaction will propagate into the secondary reaction mix portion. As will be shown in the examples, the response sensitivity and timing of the auto-shutdown can be tuned by adjusting heater geometry (reaction path), thermal resistances, and time constants of heat transfer.

The thermal sensing material is positioned intermediate between the heating source and heat sink. To maximize sensitivity of the thermal sensing material to the external environment (presence or absence of cooling substrate), the thermal sensing material generally should be close to an exterior surface of the heater cup. Thus, in many embodiments, the sensing material is adjacent to the interior wall of the bottom of the heater cup. In many embodiments, the heating device is installed into the base of a filled container, such that that the bottom wall of the heater cup is in contact with the in-cavity face of the non-easy opening end, and heat must be transferred across this surface to the interior heater dome surface and thus to the contents of the beverage container. Thus in many embodiments, the operational heat balance may involve the thermal resistances of two layers of metal sheet (the heater cup and food can walls) as well as any air gaps between these surfaces. The thermal communication between the heater face and non-easy opening surface is a consideration in achieving facile heat transfer to produce uniform and reproducible sensing of the presence or absence of a heat sink. For the examples described here it has been successfully demonstrated that sensing can be achieved with the heater device described herein installed in the non-easy opening end of a container such that two layers of metal 0.010 inches thick are in close contact.

To prevent severe overheating, the auto-shutdown mechanism may be incorporated into the heater to shut it down when a predetermined threshold temperature is sensed at a point or points in the system, such that the heater does not discharge its full energy content. For high reliability the auto-shutdown functionality is achieved in certain embodiments through the use of a simple passive feedback mechanism embedded in the heater and based on simple and robust physical principles.

Referring now back to FIG. 7 which shows the use of potential energy stored in a spring as an actuator and solder as a sensor for the auto-shutdown. As will be appreciated by those of skill in the art, several kinds of springs may be used in alternative auto-shutdown arrangements including: compression spring, extension spring, tapered spring, torsion spring, or spring metal part.

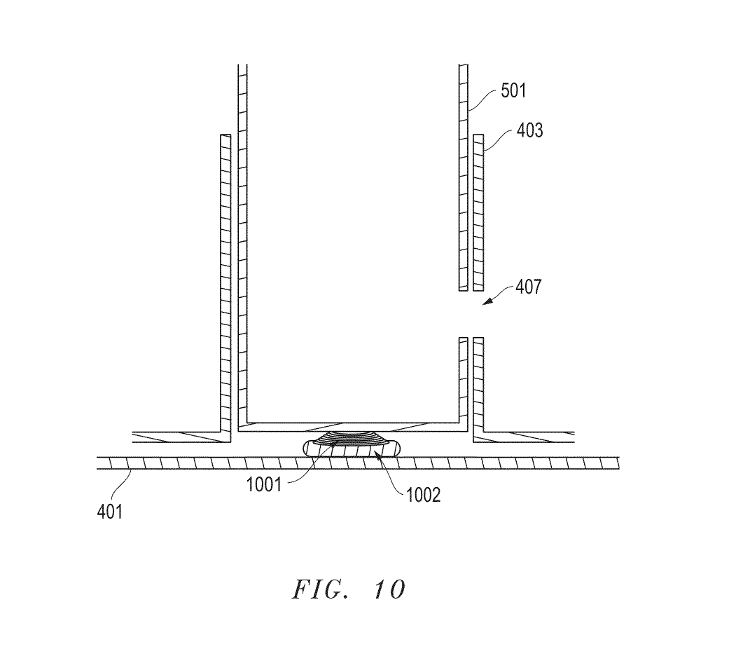

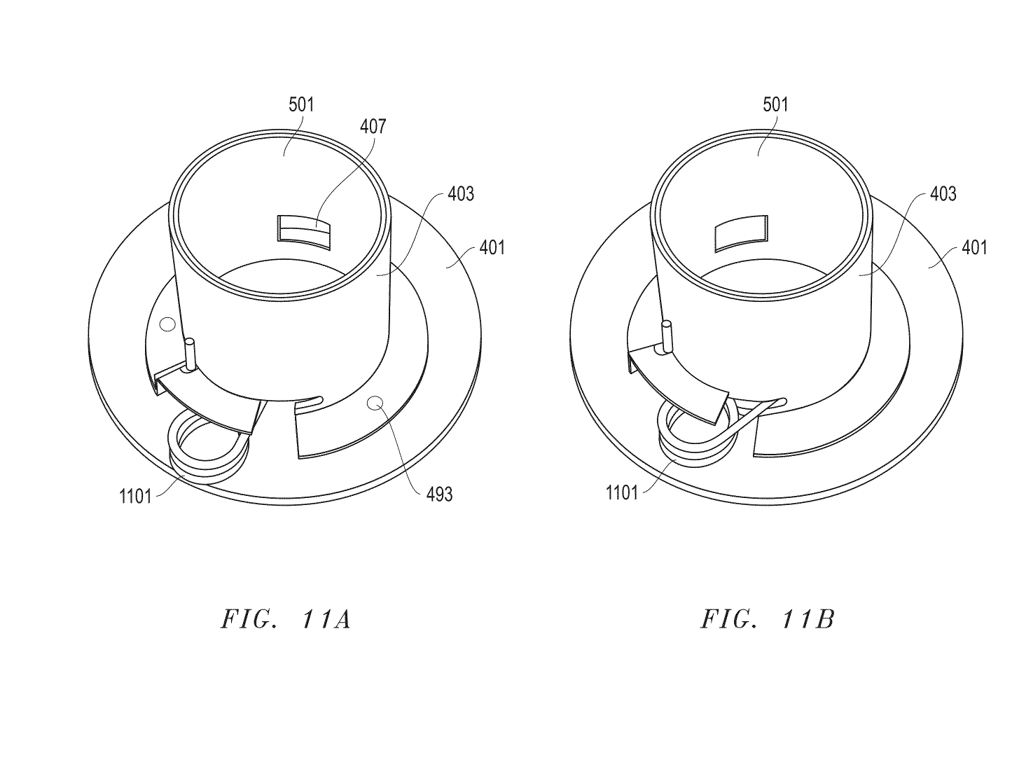

FIG. 10 shows a tapered spring 1001 compressed flat against the base of the heater cup 401 and held in place by solder 1002. FIGS. 11a and 11b show an example of an auto-shutdown implementation wherein the relative motion between the slide 501 and stovepipe 403 is a rotation. Rotation between the parts avoids or minimizes mechanical interference with other heater components such as the lid and insulation. As shown in FIG. 11, the bottom flange of the stovepipe 493 is spot welded to fix it to the base of the heater cup 401 to which the slide 501 is soldered. The parts are configured so that one leg of the torsion spring 1101 is free to rotate the slide 501 through sufficient angle to close off the propagation channel 407.

In the assembled heater the spring 1101 will be held in an energy storing when the slide 501 is soldered to the base of the heater cup 401. The melting points or ranges of various solder compositions are shown in Table 2. The solder melting point is selected accordingly to a desired auto shutdown temperature threshold, and the desired melt temperature can be fined tuned through adjustments to the solder composition.

TABLE 2

| | Melting | |
|---|---|---|
| | Point or | Melting Point or |
| Solder Composition | Range [° C.] | Range [F.] |
| 42% Sn, 58% Bi | 138 | 280 |
| 62% Sn, 36% Pb, 2% Ag | 179 | 354 |
| 63% Sn, 37% Pb | 183 | 361 |
| 50% Sn, 50% Pb | 183-215 | 361-420 |
| 96.5% Sn, 3% Ag, 0.5% Cu | 216 | 422 |
| 96% Sn, 4% Ag | 221-229 | 430-444 |
| 97% Sn, 3% Cu | 230-250 | 446-482 |
| 5% Sn, 93% Pb, 2% Ag | 280-310 | 536-590 |

The heat-generating formulation used in certain embodiments of the present invention is a mixture containing 15-25% aluminum, preferably having particle size of 2-30 microns, 20-30% silicon dioxide, preferably containing 8-18% of fumed silicon dioxide, 25-45% alumina, and additives and reaction aids such as potassium chlorate, calcium fluoride, and barium peroxide, although other combinations of materials and particle sizes may be useful in other embodiments.

The specific formulations used in one embodiment of the present invention are shown in Table 3.

TABLE 3
Example Heat-Generating Formulations

| | | Formu- | Formu- | Formu- |
|---|---|---|---|---|
| | | lation 1 | lation 2 | lation 3 |
| Content | Supplier | [wt. %] | [wt. %] | [wt. %] |
| Aluminum | Toyal America 201 | 20.9 | 20.9 | 16.6 |
| Potassium | −325Mesh | 11.0 | 11.0 | 10.0 |
| Chlorate | | | | |
| Silicon Dioxide | −325Mesh | 52.6 | 27.5 | 19.1 |
| Fumed Silicon | −325Mesh | 1.8 | 1.8 | 3.3 |
| Dioxide | | | | |
| Alumina | −325Mesh | 0 | 25.1 | 40.0 |
| Calcium Fluoride | −325Mesh | 12.7 | 12.6 | 10.0 |
| Barium Peroxide | −325Mesh | 1.0 | 1.2 | 1.0 |

### Example 1

### Torsion Spring External to the Stovepipe

Referring now to FIG. 11, wherein a stovepipe 403 with a propagation opening 407 that is approximately 4 mm high×5 mm wide is spot welded centrally inside of the heater cup 401. Slide 501 with a matching propagation opening 407 is inserted into the stovepipe 403. Torsion spring 1101 with a compression strength of approximately 1 lb/full distance of travel is mounted between the stovepipe 403 and the slide 501 in such a way that both propagation windows 407 are aligned in the spring 1101 compressed position and the spring body 1101 is outside of the stovepipe 403. The spring 1101 position is fixed by attaching the slide 501 to the heater cup 401 with a solder melting at 216° C. An amount of Formulation 1 in Table 3 approximately equal to 8.5 grams is compacted together with the starting pellet 405 at approximately 5000 psi forming a slug. The slug is then inserted into the slide 501 and 15 grams of Formulation 2 in Table 3 is compacted to proper depth around the stovepipe 403. The resulting heater is insulated internally, sealed, and inserted into a beverage or food container. When the starting pellet 405 is activated, the reaction front will start moving towards the solder. If solder is not cooled by the material that is in thermal communication with the heater cup 401, the solder will melt releasing the spring to neutral position and, therefore, closing the propagation opening 407 by rotating the slide 501. This will result in auto shutdown of the heater.

### Example 2

### Torsion Spring Inside the Stovepipe

In another example of auto shutdown application, the slide 501 is modified with an off center elongation feature that is soldered to the heater cup thus providing a void region for the torsion spring placement inside of the stovepipe 403 underneath the slide 501. The heater assembly and auto shutdown operation is similar to that described in Example 1.

### Example 3

### Compression Spring Below the Slide

One embodiment of another example of auto shutdown application is shown in FIG. 7, wherein the slide 501 is equipped with a centrally located spacer 702 enabling the compression spring 701 to be placed inside of the stovepipe 403 and around the spacer 702. To assemble the heater, a stovepipe 403 with a propagation opening 407 with dimensions of approximately 4 mm×5 mm is spot welded centrally inside of the heater cup 401. Compression spring 701 is placed centrally in the stovepipe 403 and the slide 501 with a propagation opening 407 of approximate dimensions of 4 mm×5 mm is inserted into stovepipe 403 with the spacer 702 located inside of the spring 701. The spacer's 702 length is such that when the spring 701 is in the compressed position, the spacer 702 is in contact with the bottom wall of the heater cup 401 and the propagation openings 407 are aligned. The spring 701 is fixed in the compressed position by attaching the spacer 702 to the heater cup 401 with a solder melting at 216° C. An amount of Formulation 1 in Table 3 equal to approximately 8.5 grams is compacted together with the starting pellet at approximately 5000 psi to form a slug. The slug is then inserted into the slide 501 and 15 grams of Formulation 2 in Table 3 is compacted to proper depth around the stovepipe 403. The resulting heater is insulated internally, sealed, and inserted into a beverage or food container. When the starting pellet 405 is activated, the reaction front will start moving towards the solder. If solder is not cooled by the contents being heated in the adjacent container, the solder will melt releasing the spring to neutral position and therefore, closing the propagation opening 407 by sliding the slide 501 away from the bottom wall of the heater cup 401. This will cause the propagation openings 407 in the slide 501 and the stovepipe 403 to become unaligned and result in auto shutdown of the heater.

### Example 4

### Tapered Spring Below the Slide

One embodiment of another example of auto shutdown application is shown in FIG. 10, wherein a stovepipe 403 with a propagation opening of approximately 4 mm×5 mm is spot welded centrally inside of the heater cup 401. A tapered spring 1001 is placed centrally in the stovepipe 403 and the slide 501, also with a propagation opening 407 with approximate dimensions of 4 mm×5 mm, is inserted into stovepipe 403 fully compressing the tapered spring 1001. At that position, the propagation openings 407 are aligned. The spring 1001 compressed position is fixed using a solder melting at 179° C. An amount of Formulation 1 in Table 3 equal to approximately 8.5 grams is compacted together with the starting pellet 405 at approximately 5000 psi forming a slug. The slug is then inserted into the slide 501 and 15 grams of Formulation 2 from Table 3 is compacted to proper depth around the stovepipe 403. The resulting heater is insulated internally, sealed, and inserted into a beverage or food container.

When the starting pellet 405 is activated, the reaction front will start moving towards the solder 1002. If solder 1002 is not cooled by the contents of the container adjacent to the bottom wall of the heater cup 401, the solder 1002 will melt releasing the spring 1001 to neutral position, thereby closing the propagation opening 407 by sliding the slide 501 away from the bottom wall of the heater cup 401. This will result in auto shutdown of the heater.

### Example 5

### Sublimation or Endothermically Decomposing Solids (Eds)

The auto-shutdown active material (ASDAM) may be a subliming solid or an endothermically decomposing solid (EDS), which is a material that, if heated to a certain threshold temperature, can rapidly decompose to release a volume of gas. The pressure-volume energy of the gas released is used to do some form of mechanical work that results in disruption of continuity across the propagation channel 407. Rather than creating some movement that closes off the channel, the energy of the expanding gas could be used to move the propagation channel 407 away from the reaction mixture 402 as shown for FIGS. 8a and 8b.

Endothermically decomposing solids (EDS) are chemical compounds that can be thermally decomposed to release gases and absorb energy at various activation temperatures and, in certain embodiments, may be used as thermally responsive materials for the auto-shutdown temperature control of a chemical heater. Endothermic decomposition is inherent in a broad range of common and low-cost materials suitable for a heater device. These include: magnesium and aluminum hydroxides, together with various hydrates and carbonates. Table 4 describes several endothermically decomposing solid (EDS) compounds which undergo decomposition at various onset temperatures. Many of these compounds, when thermally decomposed, give off carbon dioxide and/or water as gaseous byproducts.

TABLE 4
Properties of Various Endothermically Decomposing
Solid (EDS) Compounds

| | | Approx. | |
|---|---|---|---|
| | Approx. onset of | enthalpy of | Gaseous |
| | decomposition | decomposition | decomposition |
| Formula | (° C.) | (kJ g⁻¹) | products |
| Calcium sulfate | 60-130 | — | H₂O |
| [CaSO₄•2H₂O] | | | |
| Sodium bicarbonate | 70-150 | 1.53 | H₂O, CO₂ |
| [NaHCO₃] | | | |
| Alumina trihydrate | 180-200 | 1.30 | H₂O |
| [Al(OH)₃] | | | |
| Magnesium | 300-320 | 1.45 | H₂O |
| hydroxide | | | |
| [Mg(OH)₂] | | | |
| Huntite (mineral) | 450 | 0.99 | CO₂ |
| [Mg₃Ca(CO₃)₄] | | | |
| Siderite (mineral) | 550 | — | CO₂ |
| [FeCO₃] | | | |
| Calcium carbonate | 825 | 1.78 | CO₂ |
| [CaCO₃] | | | |

In the following examples it is again the dynamic thermal energy balance in the vicinity of the auto-shutdown material that determines the efficacy of its response. If shutdown response is needed, the auto-shutdown material must be activated before the flame front reaches the propagation channel. The response sensitivity and timing can be tuned by selecting the ASDAM, adjusting heater geometry (reaction path), thermal resistances, and time constants of heat transfer. Many other system parameters, for example ASDAM mass and thickness, the composition and density of the reaction mix, may be adjusted to achieve desired sensing and timing characteristics. Furthermore, as will be shown in the specific examples of the auto-shutdown, in order to provide the necessary time to accomplish sensing and actuation (if needed) prior to propagation, it is possible to introduce delays into the auto-shutdown system by extending the reaction path length through the device. For example, a time delay channel, that is a tortuous rather than straight-line reaction path geometry can be used to extend system event times.

Selection of ASDAM Material

The EDS is a critical component and various factors go into the selection of the EDS used for the ASDAM. It is preferable that they are low cost, environmentally friendly, and consumer safe materials. The onset temperature of the EDS selected should be such that it will not be so low as to act prematurely, or alternatively so high as to be inert. Decomposition kinetics is also important. The auto-shutdown may be best achieved by rapid volume expansion of evolved gas performing work to interrupt flame front. The energy and power available to perform the work of the auto-shutdown actuation is based on the volume rate of gas released by ASDAM decomposition. If the combination of the ASDAM used and the pertaining heat balance leads to a partial or slow release of gas rather than a sharp instantaneous release, there may be insufficient power for actuation. The processing conditions under which the ASDAM is introduced to the device may affect thermal properties and kinetics. For example, a compacted material may conduct heat better than a loose powder of the same material but then release gas from the core more slowly. Mixtures of EDS's may be used for the ASDAM.

The quantity of gas released per unit weight or volume of ASDAM as well as the ratio of non-condensable (e.g., carbon dioxide) to condensable (e.g., water vapor) gas can be a factor in how the ASDAM functions. Condensing of condensable gases in cooler parts of the system may delay actuation until the entire system is up to temperature whereas non-condensable gases have a less sharp Boyles Law dependence on system temperature. Both CO₂ and water vapor may also be consumed in chemical reactions with other materials in the reaction mix.

For the auto-shutdown to operate as described, an additional quantity of gas may be generated, either to cause the auto-shutdown, or even if by design the auto-shutdown is not activated the ASDAM may still decompose as the heater reaction proceeds to completion. The amount of gas needed to affect the auto-shutdown may be kept to a manageably small amount calibrated to do the work required by the EDS selection and quantity. As with the other reaction intermediate gases, the decomposition products of the ASDAM (typically steam and CO₂) can also recombine internally.

Alternatively or additionally, the heater design in various embodiments may be modified to allow safe and gentle release of excess pressure when the auto-shutdown activates. For example, the crimped seal between the heater cup and lid may be designed to stress relieve slightly to bleed off pressure through the seal. The heater construction may provide for any emitted gas streams to be filtered through a porous insulator so there is no emergent steam or particulates.

The auto shutdown mechanism relies on breaking the continuity of the propagation channel when the temperature of the heater exceeds the predefined threshold. This is achieved by using an expanding solid, decomposing solid, or combination of both. Examples of auto shutdown materials which are not limited to this invention but fall into that category are: sodium carbonate, sodium bicarbonate, calcium carbonate, magnesium carbonate, manganese carbonate, magnesium hydroxide, calcium hydroxide, aluminum hydroxide, magnesium carbonate basic. When the auto-shutdown material is subjected to temperature exceeding its chemical or physical change, the expansion or gas released is used to break the continuity of the propagation channel.

### Example 6

### Eds Auto-Shutdown

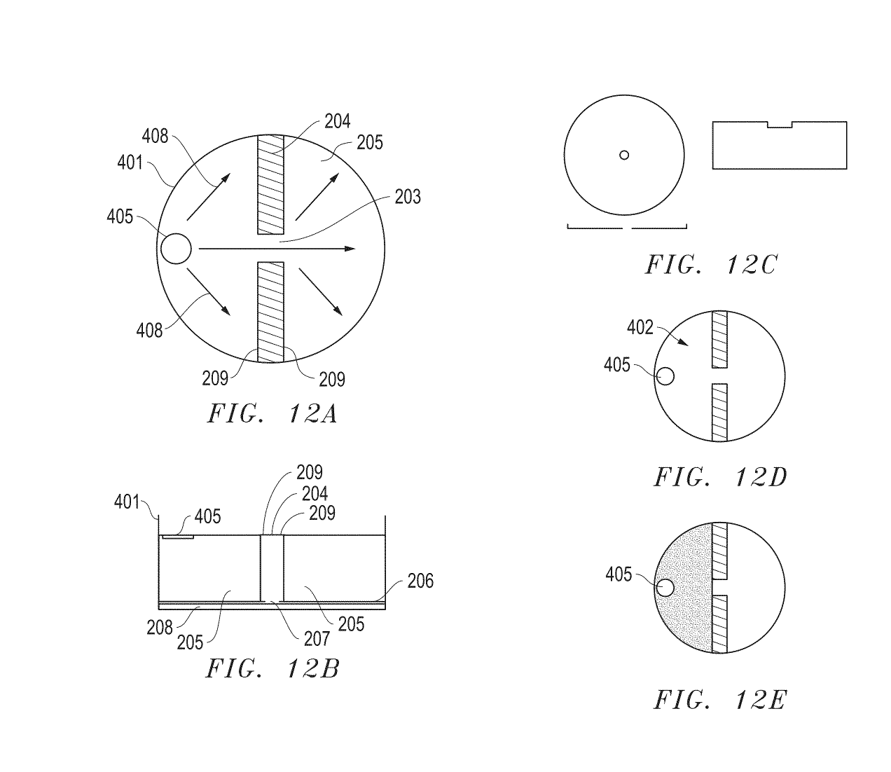

One embodiment of another example of the use of EDS in an auto shutdown application is shown in FIG. 12, wherein approximately 0.5-2.0 g of the auto-shutdown material 208 is pressed on the bottom of the heater cup 401. In this auto-shutdown example, magnesium carbonate basic is used, however similar effect will be achieved using other auto-shutdown materials. Thin aluminum foil 207 is placed on the top of the auto-shutdown material 208 followed by insertion of the internal bulkhead 206 into the heater cup 401. The internal bulkhead 206 has a press fit with the heater cup 401 leaving only the burstable aluminum foil-covered opening in internal bulkhead 206 as the possible gas escape from thermally activated auto-shutdown material 208. Approximately 25 grams of heat-generating formulation #3 205 from Table #3 is packed into the resulting heater cup 401. Two separator barriers 209 are inserted close to the center of the heater cup 401 and the heat-generating formulation between the barriers is replaced with an inert material. In a preferred embodiment, the inert material is silica, alumina, zirconium dioxide, magnesia, clay, or sand. The central channel 203 is filled with heat-generating formulation 3 from Table #3. Starting pellet 405 is placed close to the heater edge away from the barrier 209.

When the starting pellet 405 is activated, the reaction front 408 will start moving towards the auto-shutdown material and the barrier 209. If the auto-shutdown material is not cooled by the contents of the container adjacent to the bottom wall of the heater cup 401, it will decompose releasing a gas. The gas will perforate the aluminum foil 207 and clear the channel above severing the pathway across the barrier 209. This will result in auto shutdown of the heater.

### Example 7

### Eds Auto-Shutdown

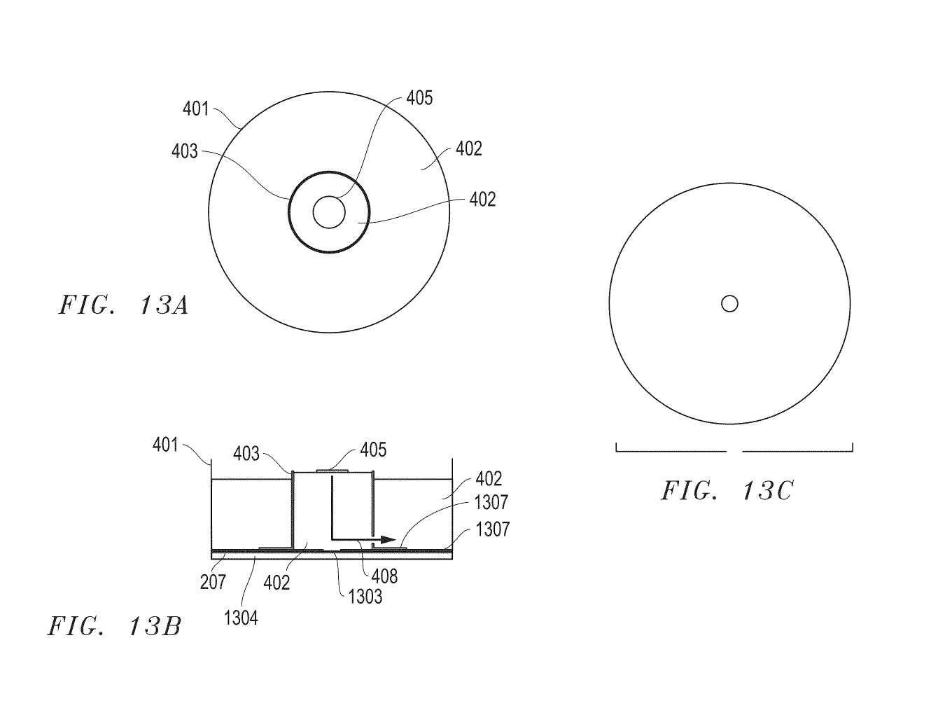

One embodiment of another example of the use of EDS in an auto shutdown application is shown in FIG. 13, wherein approximately 0.5-1.0 grams of the auto-shutdown material 1304 is pressed on the bottom of the heater cup 401. In one embodiment magnesium carbonate basic, magnesium hydroxide, or aluminum hydroxide are used as the auto-shutdown material 1304, however similar effect will be achieved using other auto-shutdown materials. Thin aluminum foil 207 is placed on the top of the auto-shutdown material 1304 followed by insertion of the internal bulkhead 1307 with a welded stovepipe 403 into the heater cup 401. The internal bulkhead 1307 has a press fit with the heater cup 401 leaving only the aluminum-foil covered opening 1303 as the possible gas escape from thermally activated auto-shutdown material 1304. Both, the heater cup 401 and the stovepipe 403 are filled with a total of approximately 25 grams of heat-generating formulation #3 1306 from Table 3. Starting pellet 405 is placed in the center of the filled stovepipe 403.

When the starting pellet 405 is activated, the reaction front 408 will start moving towards the auto-shutdown material 1304 with the parabolic shape of the front. If the auto-shutdown material 1304 is not cooled by the media being heated, it will decompose releasing a gas. The gas will perforate the aluminum foil 207 and eject the core above clearing the propagation opening 407 before the reaction front can approach the opening 407. This will result in auto shutdown of the heater.

### Example 8

### Eds Auto-Shutdown

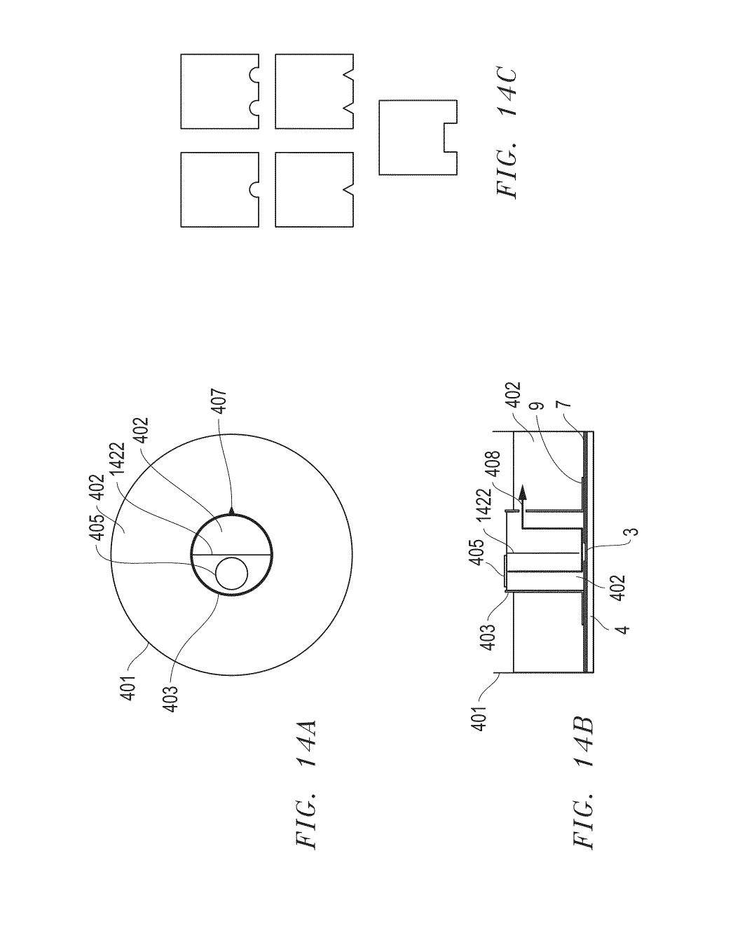

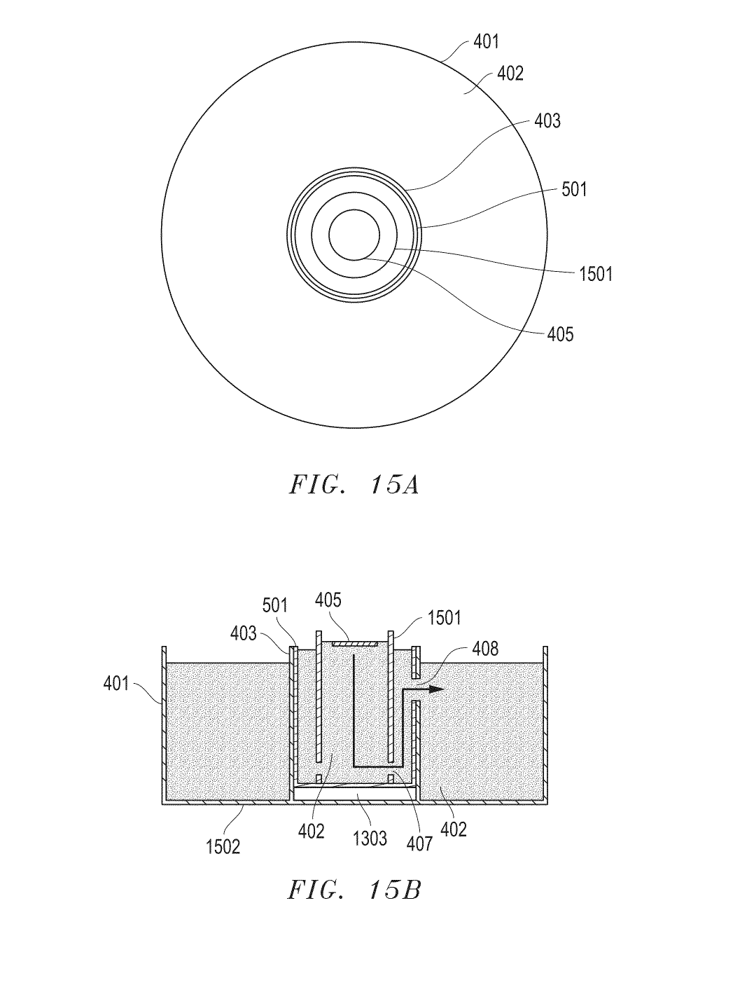

Another embodiment of the use of EDS in an auto shutdown application is shown in FIG. 14, wherein it is possible to increase the time required for the reaction front to reach the propagation opening 407 to give more time to the auto-shutdown to activate when there are no materials in the container adjacent to the bottom wall of the heater cup 401. This is more relevant for the auto-shutdown materials producing only steam during decomposition. The steam producing auto-shutdown materials are more difficult to activate and are milder in the response when there are no materials in the container adjacent to the bottom wall of the heater cup 401 and at the same time are easier to get inactivated when such materials are present, which might be important if the auto-shutdown interaction with such materials is obstructed with, for example, several layers of metal. After the stovepipe 403 and the heater cup 401 are filled with the heat-generating formulation, a barrier 1422 depicted in FIG. 14c is inserted into the stovepipe 403. The starting pellet 405 is placed on the other side of the barrier 1422 facing away from the propagation opening 407. Various configurations of the barrier 1422 are shown in FIG. 14c.

When the starting pellet 405 is activated, the reaction front 408 will start moving towards the auto-shutdown material with the parabolic shape of the front. The reaction front 408 will pass over the auto-shutdown material and then will move upward toward the propagation opening 407. If the auto-shutdown material 407 is not cooled by the materials in the container adjacent to the bottom wall of the heater cup 401, the auto-shutdown material 407 will decompose releasing a gas. The gas will perforate the aluminum foil 207 and eject the core above clearing the propagation opening 407 before the reaction front 408 can approach the opening 407. This will result in auto shutdown of the heater.

### Example 9

### Auto-Shutdown

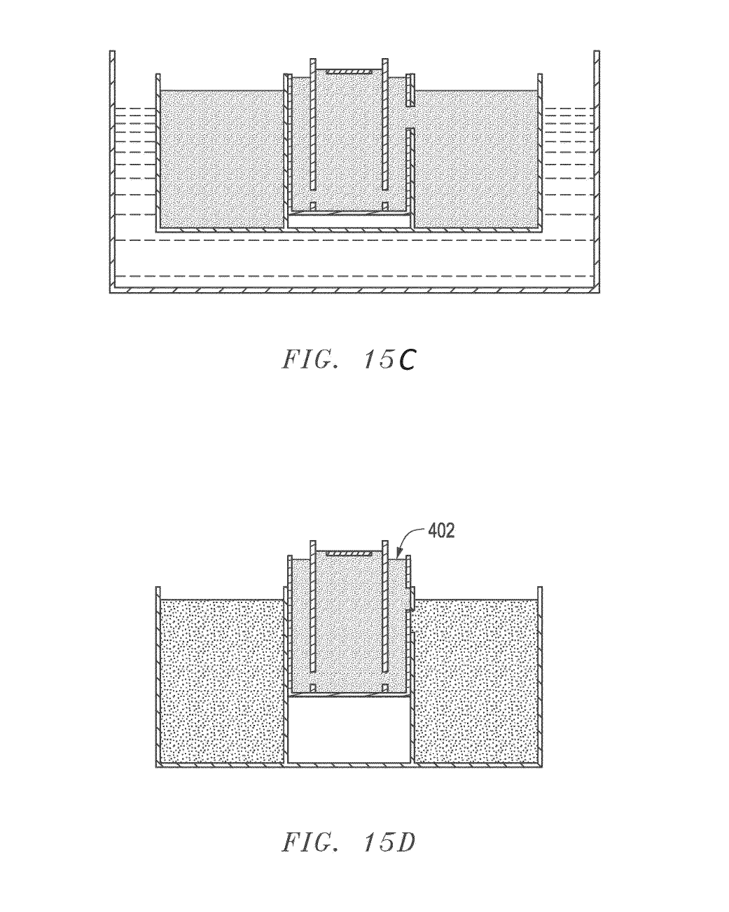

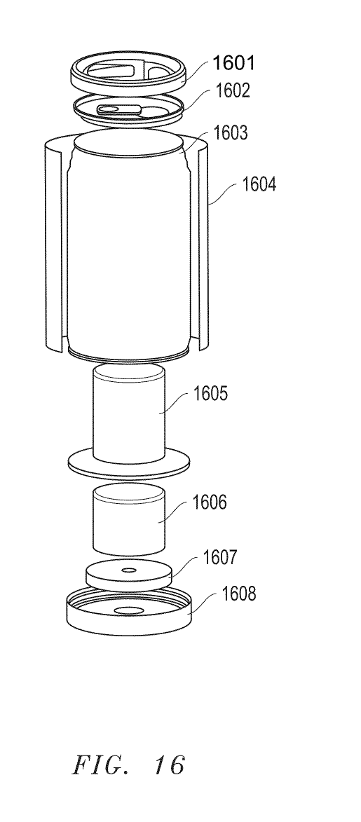

Referring now back to FIGS. 15a and 15b which show another mechanism of the auto-shutdown operation using the following approximate design parameters: approximately 21 grams of heat-generating formulation #2 of Table 3 packed into the heater cup 401 outer ring, approximately 9 grams of heat-generating formulation #2 of Table 3 packed into the slide 501, approximately 0.3 grams aluminum hydroxide auto-shutdown material 1303, approximately 9.53 mm OD 0.33 grams starting pellet 405, approximately 38 mm tall 32 mm OD heater cup 401, approximately 38 mm tall 18.12 mm ID stovepipe 403, 36.2 mm tall 17.50 mm ID slide 501, approximately 40 mm tall 13.8 mm OD inner channel pipe 1501, approximately 64 point spot welds to form a gas tight seal 1502, two 3.96 mm OD inner propagation openings 407, 3.96 mm OD propagation opening 407 in the inner pipe 1501 and the stovepipe 403 to form a passageway from the stovepipe 403 to the heat-generating formulation 402 in the outer ring of the heater cup 401. These specific design parameters are not to limit the invention to this particular embodiment but to provide a support for the specific operational parameters of the heater listed below, such as the auto-shutdown activation time, time for the reaction front to pass the propagation opening 407, removable slide 501 ejection characteristic, etc.

When the starting pellet 405 is activated, the reaction front 408 will start moving inside of the inner channel towards the auto-shutdown material 1303. Two pathways are possible as the reaction front 408 approaches the auto-shutdown material 1303. Pathway 1—the heater cooled by coffee, soup, etc. in a food container adjacent to the bottom wall of the heater cup 401 or heater simply immersed in water; or Pathway 2—the heater started in air or in an empty food container. In the case of Pathway 1, the temperature of the auto-shutdown material 1303 is kept below its decomposition temperature. As a result, the reaction front 408 follows the pathway depicted in FIG. 15b resulting in a full combustion of a heat-generating formulation as shown in FIG. 15c. In the case of Pathway 2, the auto-shutdown material 1303 is not protected from reaching the decomposition temperature and the resulting gas raises the slide 501 breaking the alignment of the propagation openings 407. As a result, the combustion of the heat-generating formulation is only in the slide 501 leaving majority of the heat-generating formulation 402 in the outer ring of the heater cup 401 unreacted.

Typical time between starting the combustion of heat-generating formulation #2 and the reaction front propagation 408 through aligned propagation openings 407 for Pathway 1 has been found to be 42.43 seconds with a standard deviation of 3.64 seconds for 24 tests. Typical time between starting the combustion of heat-generating formulation #2 and activation of the auto-shutdown material 1303 resulting in raising up/ejection of the slide 501 which breaks the continuity of the heat-generating formulation for Pathway 2 has been found to be 34.81 seconds with a standard deviation of 1.82 seconds for 32 tests. The results are presented in Table 5

TABLE 5

| Time [s] | Ejection | Propagation |
|---|---|---|
| Average | 34.81 | 42.43 |
| St. Dev. | 1.82 | 3.64 |
| # of tests | 32 | 24 |

The auto-shutdown may be used in combination with other heater and package design elements to improve user safety. The moderated solid state reaction systems which yield the heat generation are an underlying component of the auto-shutdown passive thermal control. The rate of reaction and hence heat generation power is a key metric for an energetic material in consumer heating applications. Controlled propagation enables the rate of heat generation of the system to be matched to the rate at which the heat can be efficiently transferred to substance being heated. A moderated reaction velocity also means that there is time in the system for the passive mechanism to operate. Preferred reaction systems have reaction propagation velocities of less than 1 mm s-1, giving controlled heating times of about one to four minutes.

The complete self-heating package described herein consists of several additional components besides the modular solid state heater; a complete package format are shown in FIG. 16. In these examples, the self-heating package is a 3-piece (nominally) 12 oz. beverage container. However, embodiments of the invention may alternatively be realized with a 2-piece beverage container or other package forms.

Referring to FIG. 16, the can body 1603 and top end 1602, consisting of, in at least one embodiment, an easy opening lid for convenience, are conventional can package components. The non-easy-opening (NEO) end 1605 is specifically designed for mechanical and thermal interfacing of the package and heater. Various features may be incorporated into the NEO as described below. An insulating plastic lip guard 1601 and paper or plastic thermal label 1604 provide thermal safety. Once the heater is installed in the NEO, there are additional components at the heated end of the can; these may include an external insulator 1607 which may be a non-woven polymer or fiberglass mat and a plastic base cap 1608. The external insulator may also incorporate materials such as activated carbon or baking soda to absorb any trace odors emitted by the activated heater.

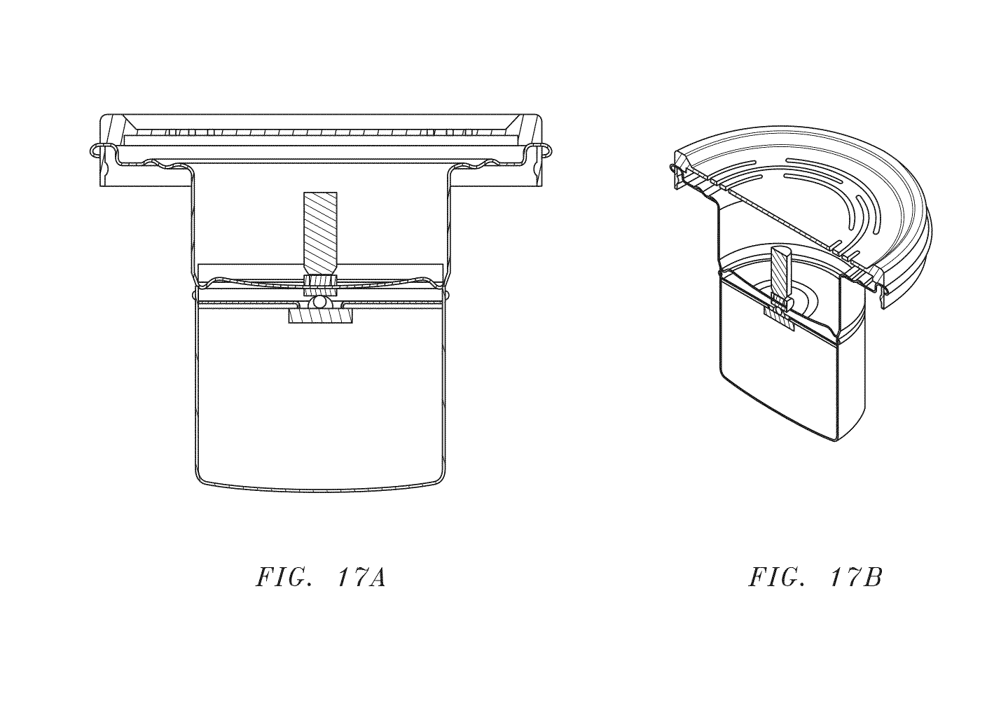

The circumferential edge of the NEO 1605 is specifically formed with a pre-curl to facilitate double seaming onto a food or beverage package. The NEO should further incorporate design functionality such that the heater once installed is firmly held in position against accidental dislodgement. At the same time the heater must be capable of insertion into filled food cans at high production speeds without undue installation force that could cause the cans to burst or leak. FIGS. 17a and 17b show a cross section of a modular heater inserted into a deep drawn NEO, of a type that could be used to position the heater near the center of the package. The NEO of FIGS. 17a and 17b also includes a domed end surface for shedding of bubbles in the heater uppermost orientation. The domed end is closely matched to the heater curvature for good thermal contact.

The deep drawn NEO shown in FIGS. 17a and 17b has a two stage diameter, such that the outermost portion of the cavity provides greatly reduced frictional resistance during insertion whereas the smaller diameter of the innermost NEO cavity that is adjacent to the installed heater surfaces provides the low clearance described as essential for good thermal contact.

Installation of the heater during manufacturing should be facile, yet at the same time inadvertent dislodgement of the heater during consumer use should be prevented. The heater may be inserted into the cavity of the package in such a manner that the heater and NEO surfaces are thermally communicatively coupled for efficient heat transfer.

Also shown in FIGS. 17a and 17b is a concentric groove or bead which is post-formed into the NEO once it has been stamped and drawn. This bead is designed and produced such that it will not damage the epoxy or lacquer coating on the interior of the can that provides surface protection and compatibility with the food or beverage contents. The bead provides a female mating surface that engages with a corresponding male feature produced on the heater periphery (not shown). The mutually interlocking features on the NEO end and the heater are to be positioned along their respective axes so that the inner face of the heater is pressed into or maintained in close contact with the interior surface of the NEO end.

In many of the invention examples the container has been described as a conventional 3-piece or 2-piece metal food or beverage can. Metal cans formed from aluminum or tinplated steel have certain preferred characteristics in terms of thermal and mechanical properties, including good mechanical strength for securely housing the heater and good thermal conductivity for transmitting the heat through the package wall and are stable against softening at high temperatures. These properties are well suited for the compact, energy dense, solid state heater of this invention, and in particular for the NEO component of the package.

Various food safe polymers are readily formed into semi rigid containers for food and beverage applications. Semi rigid packages are primarily composed of single or multi-layers of different types of plastic materials such as polyethylene and polypropylene; however, some packages are manufactured with a paperboard and/or foil component. A wide variety of sizes (from 3 to 26-ounces) and shapes (bowls, shaped cups, straight-sided containers) can readily be produced. Semi-rigid containers can be processed in thermal processing systems for commercially sterile and shelf-stable products such as: in retorted, hot-filled, cold-filled and aseptic operations for both high- and low-acid foods. The containers may be formed by blow molding or thermoforming. Closures are joined onto the containers by heat sealing or double seaming.

While, the double seamed metal can has long provided a means for the food processor to obtain a high level of container integrity and is widely accepted package for shelf-stable foods, the plastic package with a double seamed end can now also provide a high level of container integrity. As with its metal counterpart, the double seamed on a plastic container consists of five thicknesses of material: in the latter instance including three thicknesses of metal from the end plus the flange and neck of the plastic container. These are folded, interlocked and pressed firmly together by the same basic closing machines used for metal cans. The container is typically shaped as a cup or bowl and may have a plastic cap covering scored metal end with a pull-tab for consumer convenience.

Hybrid packaging solutions combining the best performance characteristics of both metal and plastic are known in the prior art to offer both convenience and performance. Examples of prior art hybrid packages include both microwavable multilayer plastic bowls and cups with easy-opening metal ends. These containers target convenience applications such as shelf-stable foods packaged in single servings for microwaving.

An object of this invention is to provide a form of self-heated package that synergistically combines the advantage of the better heat transfer and mechanical and thermal stability of the metal NEO end with the formability, thermally insulating, and low cost benefits of polymers, wherein the metal NEO end that holds the heater is sealed or seamed onto to a polymer package sidewall.

While the present device has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” or “thermally connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible heating methods and systems available, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A heating device comprising:
a reaction chamber consisting of a primary reaction chamber and a secondary reaction chamber;
a reaction composition disposed within the reaction chamber;
an activator mechanism connected to the primary reaction chamber such that the activator mechanism is configured to initiate a reaction in the reaction composition in the primary reaction chamber but not in the secondary reaction chamber, and wherein the reaction in the primary reaction chamber is configured to initiate a reaction in the reaction composition in the secondary reaction chamber; and
wherein the primary reaction chamber is configured to prevent the reaction composition in the secondary reaction chamber from reacting if the temperature in the primary reaction chamber exceeds a predetermined value.

2. The device of claim 1 wherein the reaction chamber is thermally connected to the interior space of a container that is configured to receive a substance to be heated.

3. The device of claim 1 wherein the primary reaction chamber includes a wall with a propagation opening through which the reaction in the primary reaction chamber initiates the reaction in the reaction composition in the secondary reaction chamber.

4. The device of claim 1, wherein the primary reaction chamber includes a propagation opening between the primary reaction chamber and the secondary reaction chamber, and further including a slide positioned inside the primary reaction chamber wherein the slide includes a propagation opening aligned with the propagation opening of the primary reaction chamber, wherein the propagation opening in the first reaction chamber and the propagation opening in the second reaction chamber are aligned when the temperature in the first reaction chamber is below the predetermined value and the propagation opening in the first reaction chamber and the propagation opening in the second reaction chamber are not aligned when the temperature in the first reaction chamber exceeds the predetermined value.

5. A heating device comprising:
a primary reaction chamber;
a secondary reaction chamber;
a primary reaction composition disposed within the primary reaction chamber;
a secondary reaction composition disposed within the secondary reaction chamber;
a propagation opening in a wall of the first reaction chamber through which the primary reaction composition is in thermal communication with the secondary reaction composition;
a slide positioned inside the primary reaction chamber, said slide having a propagation opening configured similarly to the propagation opening in the wall of the first reaction chamber;
a spring connected to the slide and positioned in energized state such that the propagation opening in a wall of the first reaction chamber is aligned with the propagation opening in the slide;
solder connected to the slide and securing the spring in its energized state, the solder being in thermal communication with the primary reaction composition;
wherein when the temperature of the primary reaction composition exceeds the melting temperature of the solder, the spring moves from its energized state to its relaxed state causing the slide to move to a position in which the propagation opening in the wall of the first reaction chamber is no longer aligned with the propagation opening in the slide.

6. The device of claim 5 wherein the primary reaction chamber and the secondary reaction chamber are thermally connected to the interior space of a container that is configured to receive a substance to be heated.

7. The device of claim 5 wherein the primary reaction composition and the secondary reaction composition are the same composition.

8. The device of claim 5, further including an activator mechanism connected to the primary reaction chamber such that the activator mechanism is configured to initiate a reaction in the primary reaction composition but not in the secondary reaction composition.

9. The device of claim 5 wherein the mass of the primary reaction composition is less than twenty five percent of the mass of the secondary reaction composition.

10. The device of claim 5, wherein the ratio of the mass of the secondary reaction composition to the mass of the primary reaction composition is less than 9:1.

11. A heating device comprising:
a primary reaction chamber;
a secondary reaction chamber;
a primary reaction composition disposed within the primary reaction chamber;
a secondary reaction composition disposed within the secondary reaction chamber;
a propagation opening in a wall of the first reaction chamber through which the primary reaction composition is in thermal communication with the secondary reaction composition;
a slide positioned inside the primary reaction chamber, said slide having a propagation opening configured similarly to the propagation opening in the wall of the first reaction chamber;
an endothermically decomposing solid positioned adjacent to the slide such that the propagation opening in a wall of the first reaction chamber is aligned with the propagation opening in the slide, the endothermically decomposing solid being in thermal communication with the primary reaction composition;
wherein when the temperature of the primary reaction composition exceeds the activation temperature of the endothermically decomposing solid, the endothermically decomposing solid expands causing the slide to move to a position in which the propagation opening in the wall of the first reaction chamber is no longer aligned with the propagation opening in the slide.

12. The device of claim 11 wherein the primary reaction chamber and the secondary reaction chamber are thermally connected to the interior space of a container that is configured to receive a substance to be heated.

13. The device of claim 11, further including an activator mechanism connected to the primary reaction chamber such that the activator mechanism is configured to initiate a reaction in the primary reaction composition but not in the secondary reaction composition.

14. The device of claim 11 wherein the mass of the primary reaction composition is less than twenty five percent of the mass of the secondary reaction composition.

15. The device of claim 11, wherein the ratio of the mass of the secondary reaction composition to the mass of the primary reaction composition is less than 9:1.

16. A method of automatically stopping a reaction in a reaction chamber comprising:
positioning a first reaction composition in a first reaction chamber;
positioning a second reaction composition in a second reaction chamber, wherein a propagation opening in a wall of the first reaction chamber allows the first reaction composition to be in thermal communication with the second reaction composition;
positioning a slide inside the primary reaction chamber, the slide having a propagation opening configured similarly to the propagation opening in the wall of the first reaction chamber;
connecting a sprint to the slide such that, in the spring's compressed state, the propagation opening in the wall of the first reaction chamber is aligned with the propagation opening in the slide;
soldering the slide to secure the spring in its compressed state, wherein the solder is in thermal communication with the primary reaction composition; and
when the temperature of the primary reaction composition exceeds the melting temperature of the solder, allowing the spring to expand, thereby causing the slide to move to a position in which the propagation opening in the wall of the first reaction chamber is no longer aligned with the propagation opening in the slide.

17. The method of claim 16 wherein the primary reaction chamber and the secondary reaction chamber are thermally connected to the interior space of a container that is configured to receive a substance to be heated.

18. The method of claim 16, further including an activator mechanism connected to the primary reaction chamber such that the activator mechanism is configured to initiate a reaction in the primary reaction composition but not in the secondary reaction composition.

19. The method of claim 16 wherein the mass of the primary reaction composition is less than twenty five percent of the mass of the secondary reaction composition.

20. The method of claim 16, wherein the ratio of the mass of the secondary reaction composition to the mass of the primary reaction composition is less than 9:1.
